(19) United States
(12) Patent Application Publication
(10) Pub. No.: US 2008/0167944 A1
(43) Pub. Date: Jul. 10, 2008

(54) Method and system for determining transactional data between a consumer and a merchant engaged in a purchase transaction

(75) Inventors: Thomas H. Keithley, Monkton, MD (US); Mark L. Lavelle, Govans, MD (US); Vincent W. Talbert, Cockeysville, MD (US)

Correspondence Address: THE WEBB LAW FIRM, P.C., 700 KOPPERS BUILDING, 436 SEVENTH AVENUE, PITTSBURGH, PA, 15219, US

(73) Assignee: I4 Commerce Inc., Timonium, MD (US)

(21) Appl. No.: 11/651,143

(22) Filed: Jan. 9, 2007

(51) Int. Cl. G06Q 50/00

(52) U.S. Cl. 705/10

(57) ABSTRACT

A method for determining transactional data between a consumer and a merchant engaged in a purchase transaction. This method includes the steps of: initiating or consummating a purchase transaction, such as an online credit transaction, between at least one consumer and at least one merchant; generating a transaction data set including a plurality of data fields populated with consumer data, merchant data, transaction data, purchase data or any combination thereof; processing the plurality of data fields of the transaction data; and presenting a purchase data set including at least one data field therein.

### BACKGROUND OF THE INVENTION

1. Field of the Invention

The present invention is related generally to payment and purchase systems and consumer/payment system relationships and consumer/merchant relationships and, in particular, to a method and system for determining transactional data between a consumer and a merchant engaged in a purchase transaction, such as an online purchase transaction, which data may be utilized by the merchant, a credit issuer, an online payment system etc.

2. Description of Related Art

In order to enable convenient purchases of goods and services by consumers, the financial service industry has developed many alternative payment methods that allow a consumer to engage in a transaction and receive goods and services on credit. For example, such alternative payment methods may include checks, ATM or debit cards, credit cards, charge cards, etc. Prior to the birth of virtual commerce, as discussed below, such payment options provided adequate convenience and transactional security to consumers and merchants in the marketplace. Virtual commerce and the growth of the Internet as a medium for commerce have placed pressure on the payment options discussed above on the convenience, transactional security and profitability by the credit issuer. Currently, available payment options include significant shortcomings when applied to remote purchasers, such as purchases where the buyer and the seller (that is, the merchant) are not physically proximate during the transaction. Specific examples of remote purchases are mail order, telephone order, the Internet and wireless purchases.

In a typical credit transaction and process, a consumer engages with a merchant at the point-of-sale, such as online at the merchant's website, at the merchant's business or store, over the telephone with the merchant's call/sales center, etc. The merchant sends a request to the credit issuer to obtain authorization or verification data for allowing the consumer to consummate the sale. For example, the credit issuer may indicate to the merchant whether the consumer is creditworthy, is over his or her limit, is verified, has the available fumds/balance to make the purchase, etc.

Once consummated, the credit issuer provides the merchant with certain transactional data on a periodic basis. For example, on a monthly basis, the credit issuer may provide the merchant with a listing of all credit transactions for their credit product and the total amount of each consumer's transaction. Using this information, the merchant is able only to determine the total amount a consumer spent using a specific credit product on a specific day.

Although credit transactions have been discussed, other purchase methods are available and yield valuable data. For example, even cash, check, debit and other electronic payment transactions provide important transactional and consumer data. This information would also be useful in connection with analyzing the actions and experiences of both the consumer and the merchant.

While the above-discussed total transaction value data is somewhat useful in making a limited amount of business decisions, it has the potential to be much more robust. If the merchant has additional transactional data from a system, a wide variety of useful and beneficial business decisions could be made, including: offers to the consumer, discounts, advertising directives, website analysis and streamlining, identification of potential consumers, other merchant data, reasons for lost consumers, etc. This lack of information represents a deficiency in the consumer/merchant/credit issuer relationship.

### SUMMARY OF THE INVENTION

Therefore, it is an object of the present invention to provide a method and system for determining transactional data between a consumer and a merchant engaged in a purchase transaction that overcomes the drawbacks and deficiencies of the prior art. It is another object of the present invention to provide a method and system for determining transactional data between a consumer and a merchant engaged in a purchase transaction that provides the merchant with valuable transactional data It is yet another object of the present invention to provide a method and system for determining transactional data between a consumer and a merchant engaged in a purchase transaction that collects, processes, analyzes and/or supplies transactional data. It is a still further object of the present invention to provide a method and system for determining transactional data between a consumer and a merchant engaged in a purchase transaction that provides a user, such as a merchant, with a purchase data set, such as in the form of an analytical report based upon this transactional data.

The present invention is directed to a method for determining transactional data between a consumer and a merchant engaged in a purchase transaction. This method includes the steps of: initiating or consummating a purchase transaction between at least one consumer and at least one merchant; generating a transaction data set including a plurality of data fields populated with consumer data, merchant data, transaction data, purchase data or any combination thereof; processing the plurality of data fields of the transaction data set; and presenting a purchase data set including at least one data field therein.

This purchase data set may be presented in the form of an analytical report. In addition, the analytical report may include an itemized list of purchased items or services, category data of purchased items or services, price data of purchased items or services, manufacturer of purchased items, provider of purchased services, identification of items or services, associated purchasing consumer, consumer type, associated selling merchant, merchant type, associated credit issuer, credit issuer type, credit data, credit product data, no-purchase data, consumer choice data or any combination thereof.

The present invention is further directed to an apparatus for determining transactional data between a consumer and a merchant engaged in a purchase transaction. This apparatus includes: means for initiating or consummating a purchase transaction between at least one consumer and at least one merchant; means for generating a transaction data set including a plurality of data fields populated with consumer data, merchant data, transaction data, purchase data or any combination thereof; means for processing the plurality of data fields of the transaction data set; and means for presenting a purchase data set including at least one data field therein.

Still further, the present invention is directed to a system for determining transactional data between a consumer and a merchant engaged in a purchase transaction. This system includes a storage mechanism having a transaction database. An input mechanism is used for transmitting, to the storage mechanism, a transaction data set having a plurality of data fields populated with consumer data, merchant data, transaction data, purchase data or any combination thereof. A processor mechanism processes data input, data requests, data manipulation, data transmission, or any combination thereof. In addition, the system includes a merchant output mechanism for presenting, to a user, e.g., the merchant, a purchase data set including at least one data field therein.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a step flow diagram of one embodiment of a method for determining transactional data between a consumer and a merchant engaged in a purchase transaction according to the present invention;

FIG. 2 is an example of a purchase data set in the form of an analytical report presented in accordance with a method and system for determining transactional data between a consumer and a merchant engaged in a purchase transaction according to the present invention;

FIG. 3 is another example of a purchase data set in the form of an analytical report presented in accordance with a method and system for determining transactional data between a consumer and a merchant engaged in a purchase transaction according to the present invention;

FIG. 4 is a schematic view of one embodiment of a method and system for determining transactional data between a consumer and a merchant engaged in a purchase transaction according to the present invention;

FIG. 5 is a schematic view of another embodiment of a method and system for determining transactional data between a consumer and a merchant engaged in a purchase transaction according to the present invention; and

FIG. 6 is a schematic view of a further embodiment of a method and system for determining transactional data between a consumer and a merchant engaged in a purchase transaction according to the present invention.

### DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention is directed to a method 100 and system 10 for use in determining transactional data between a consumer C and a merchant M engaged in a purchase transaction. In particular, the method 100 and system 10 are used to present, to a user, a purchase data set 12. For example, the user may be the above-mentioned merchant M or other party.

The presently-invented method 100 and system 10 are useful in connection with credit-based transactions involving a variety of credit products, such as credit cards, online credit accounts, and other similar credit vehicles. In addition, the presently-invented method 100 and system 10 can be used in connection with a variety of payment methods and structures, such as online payment, cash transactions, debit transactions, check transactions, electronic checks, etc. Further, the method 100 and system 10 of the present invention can be used in connection with a variety and any quantity of credit issuers CI, payment systems, online payment systems, consumers C and merchants M, and at a variety of points-of-sale, such as at an in-store location, over the telephone, in an online environment, etc.

The purchase data set 12 can be presented or delivered to any of these entities whether or not involved in the purchase transaction. Accordingly, the purchase data set 12 can be presented, delivered or communicated to transacting merchant M at any time during or after the transaction, or even to another merchant M during or after this transaction. Therefore, the presently-invented method 100 and system 10 provides a dynamic delivery of data (in the form of a purchase data set 12) to a user.

This purchase data set 12 can include a variety of data fields and take a variety of forms. For example, as discussed in detail hereinafter, the purchase data set 12 may be in the form of an analytical report 24 having multiple data points. However, the purchase data set 12 may include scores, data, codes, keys, values, identifiers, etc. for presentation to the user to effectively use the data in making transactional, advertising, business, financial and other decisions.

The presently-invented method 100 and system 10 may take a variety of forms. For example, in one embodiment, the method 100 and system 10 are implemented wholly or partially in an online environment, such as through the use of servers, networked computers and the Internet. Alternatively, the method 100 and system 10 may be in the form of a downloadable program or applet located on a merchant, consumer or other system.

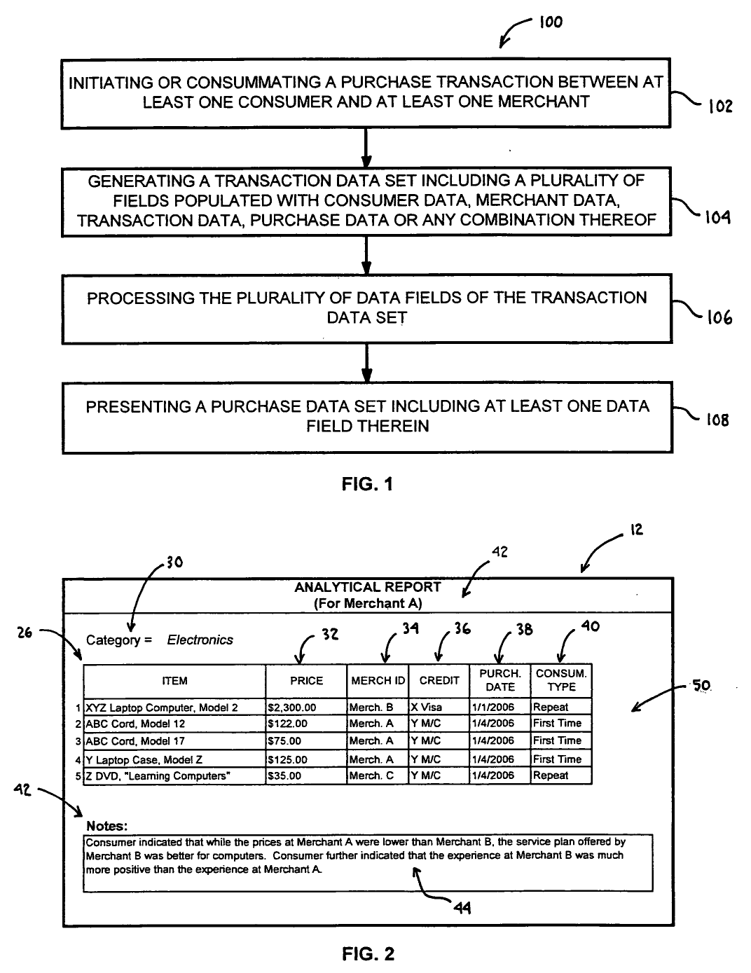

With reference to FIG. 1, and in one preferred and non-limiting embodiment, the method 100 of the present invention includes: initiating or consummating a purchase transaction between at least one consumer C and at least one merchant M (Step 102); generating a transaction data set 13 including a plurality of data fields populated with the consumer data, merchant data, transaction data, purchase data or any combination thereof (Step 104); processing the plurality of data fields of the transaction data set 13 (Step 106); and presenting a purchase data set 12 including at least one data field therein (Step 108). By employing this method 100, the purchase data set 12 (e.g., the analytical report 24) is developed and presented to a specified party, which, in one preferred and non-limiting embodiment, would be the merchant M. However, the presently-invented method 100 and system 10 are not limited to presenting the purchase data set 12 to only a merchant M. For example, a credit issuer CI may also gather the requisite information and, after analysis, have such a purchase data set 12 or an analytical report 24 presented thereto.

In one embodiment, the presently-invented method 100 is in the form of a system 10 that provides an automated or computerized platform to enable this method 100. Accordingly, the system 10 is capable of determining certain transactional data between the consumer C and the merchant M engaged in a purchase transaction before, during or after the purchase transaction is consummated. In particular, the system 10 generates a transaction data set 13 including a plurality of data fields 14 populated with consumer data 16, merchant data 18, transaction data 20, credit data 22 or any combination thereof. Further, the system 10 includes the appropriate programming, algorithms and engines to process and/or analyze the transaction data set 13 based upon one or more of the data fields 14 in the transaction data set 13. Finally, the system 10 is capable of generating and presenting a purchase data set 12, such as in the form of an analytical report 24, to a user, such as a merchant M.

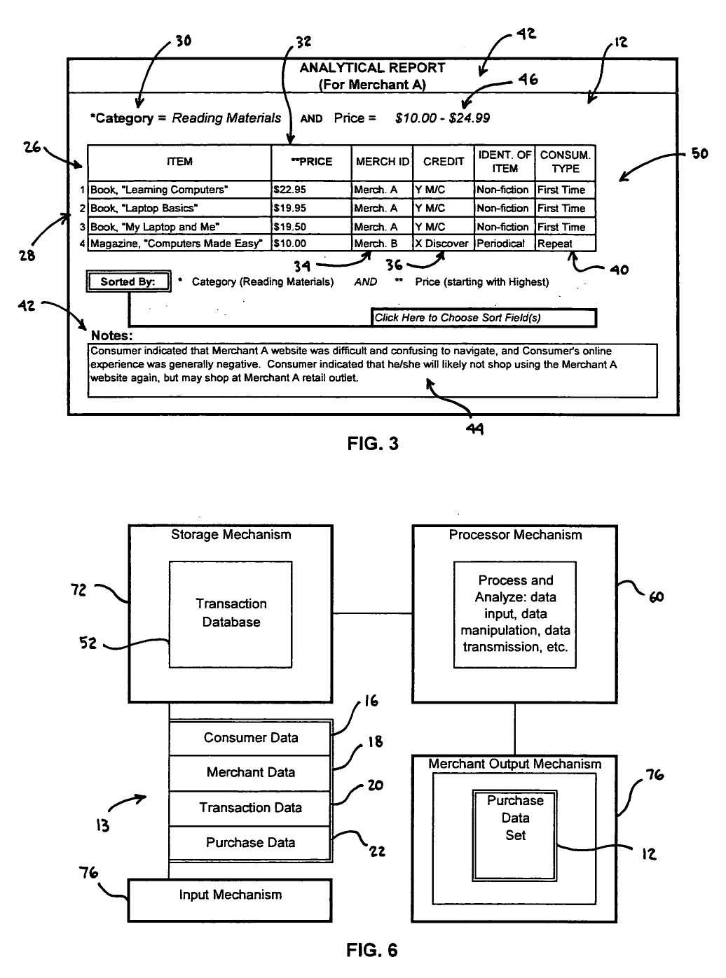

FIGS. 2 and 3 illustrate two exemplary analytical reports 24 that could be presented to the user. A variety of information and data can be provided in this analytical report 24, including, but not limited to, an itemized list of purchased items or services, category data of purchased items or services, price data of purchased items or services, manufacturer of purchased items, provider of purchased services, identification of items or services, associated purchasing consumer, consumer type, associated selling merchant, merchant type, payment system, associated payment system, associated credit issuer, credit issuer type, credit data, credit product data, no-purchase data, consumer choice data, etc. All of this information and data provides the user with a much better picture of the purchase transaction for use in making additional decisions regarding that transaction or future transactions with the same or different consumers C, and by the transacting merchant M or another merchant M.

With specific reference to FIG. 2, the analytical report 24 includes an itemized list 26 of purchased items 28. Further, the list 26 is grouped according to category 30, and in this example, the category 30 is “electronics”. Therefore, the analytical report 24 provides a listing of “electronics” items 28 purchased by specified consumers C.

The analytical report 24 provides additional information, including the price 32 of the item 28, an identification 34 of the merchant M, credit product data 36, purchase date 38 and consumer type 40. The identification 34 of the merchant M would be a specific notation or other means for identifying the merchant M from whom the consumer C purchased the item 28. The credit product data 36 identifies the type of credit product used by the consumer C in the transaction. The purchase date 38 indicates when the consumer C purchased the item 28 from the merchant M, and the consumer type 40 indicates what type of consumer C made the purchase, such as a “repeat” consumer C or a “first time” consumer C.

The analytical report 24 can also provide additional useful information and data, as indicated by the “notes” section 42 at the bottom of the report 24. As seen in this exemplary embodiment, the “notes” section 42 includes consumer action data 44 regarding why the consumer or consumers acted in the manner that they did with respect to the merchant M. For example, in this example, the consumer indicated that while the price at Merchant “A” was lower than Merchant “B”, the service plan offered by Merchant “B” was better for computers. This consumer further indicated that the experience at Merchant “B” was much more positive than the experience at Merchant “A”. Therefore, Merchant “A” (to whom the analytical report 24 is directed) now has a better understanding of the consumer C experience with respect to the merchant M, as well as the reasons purchases were made at different merchants M.

As seen in another exemplary embodiment of an analytical report 24 sent to a merchant M, FIG. 3 illustrates additional data and information that can be presented to the merchant M. In this embodiment, the analytical report 24 includes both the category 30, as well as a price range 46. As discussed above in connection with the analytical report 24 of FIG. 2, the analytical report 24 of FIG. 3 also includes the itemized list 26 of purchased items 28, the price 32, the identification 34 of the merchant M, credit product data 36 and consumer type 40. In addition, the analytical report 24 of this embodiment includes item identification 48. In this example, since the items 28 are in the category 30 of “reading materials”, the item identification 48 includes the various types of reading materials, such as “non-fiction” and “periodical”. Further, in the “notes” section 42, the consumer action data 44 indicates that the consumer C had a negative experience at the website of Merchant “A”, indicating that is was difficult and confusing to navigate. Consumer C further indicates that he or she would likely not shop using the Merchant “A” website again, but may shop at the Merchant “A” retail outlet.

While not specifically required, in one preferred and non-limiting embodiment, the the purchase data set 12 or analytical report 24 is in electronic form. Of course, a hard copy of this purchase data set 12 or analytical report 24 could also be sent to the merchant M. Still further, in the embodiment where the purchase data set 12 or analytical report 24 is in electronic form, this data set 12 or report 24 includes multiple data fields 50, which are presented to a user, such as the merchant M.

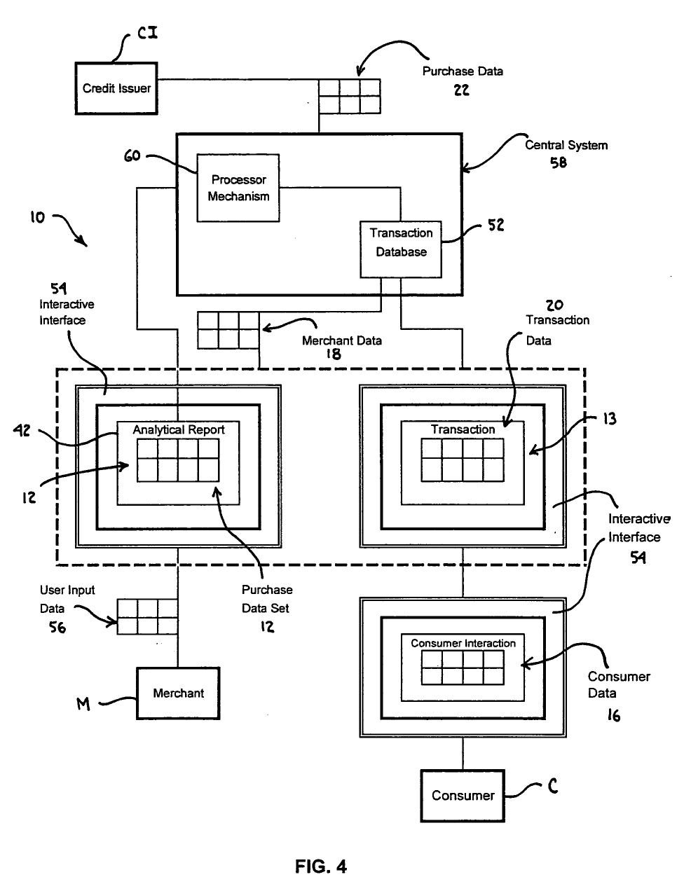

In order to present the purchase data set 12 (in this embodiment, the analytical report 24) in electronic form, and as seen in FIG. 4, a transaction database 52 is built and includes multiple data fields populated with some or all of the data fields 14 of the transaction data set 13. In this embodiment, the analytical report 24 is presented to the user on an interactive interface 54, which is in communication with the transaction database 52 and is configured to accept input data 56 from the user.

The interactive interface 54 is in communication with a central system 58, which is in communication with or otherwise houses the transaction database 52 discussed above. In addition, this central system 58 may be configured or programmed to authenticate the consumer C, verify the consumer C, approve or deny the transaction, verify the transaction, process consumer data 16, process merchant data 18, process transaction data 20, process credit issuer CI data, process payment system data, process credit data 22, process credit product data 36, etc. In order to process this information and appropriately analyze it, the central system 58 may include a processor mechanism 60. This processor mechanism includes the appropriate engines, algorithms and programs to analyze, sort, arrange and present the analytical report 24 to the user, such as the merchant M.

As discussed above, the interactive interface 54 allows the user to provide input data 56 that can be used in connection with the analytical report 24. For example, as seen in FIG. 3, the data fields 50 of the analytical report 24 may be arrangeable, sortable or configurable. For example, the user may provide the input data 56 that allows the dynamic purchase data set 12 and/or analytical report 24 to arrange, sort and configure the data fields 14, 50 of the data set 12 or report 24. In this embodiment, the input data 56 may be the category 30 (such as the category of the purchased items 28 or services), the price 32 of the purchased items 28 or services, the manufacturer of the purchased items 28, the provider of the purchased services, the item identification 48 or service identification, associated purchasing consumer C, associated selling merchant M, associated credit issuer CI, purchase (or credit) data 22, credit product data 36, no-purchase data, consumer choice data, consumer action data 44, keyword data, key-phrase data, search data, etc.

As seen in the embodiment of FIG. 3, the report 24 indicates that it has been sorted by category 30 and price 32 (within a selected price range 46). In particular, the top-level sort field is category 30, in this case reading materials, and the second-level sort field is price 32, starting with the highest price. In this manner, the user or merchant M can easily arrange and sort the data fields 50 of the analytical report 24 into the desired form for use in additional analytical processes.

Returning to the embodiment of FIG. 4, both the transaction database 52 and the processor mechanism 60 are included with or associated with a central system 58. In one embodiment, this central system 58 is maintained by or otherwise in the control of the payment system, such as the credit issuer CI, who provides credit data 22 thereto. Of course, the transaction database 52 may be maintained by a variety of entities and in a variety of forms, such as by the credit issuer CI, the merchant M, a third party, in an online environment, in electronic form, on a website, on an accessible medium, on a protected medium, as part of a system, as part of a third-party service system, as part of a payment system, as part of an online payment system, as part of a merchant M system, etc.

As seen in FIG. 4, it is also envisioned that the consumer C may also have access to an interactive interface 54, which may be presented by the merchant M at a merchant website or other online format. For example, the consumer C may input consumer data 16 into the system 10 through an interactive interface 54, and transaction data 20 can be provided to the system 10 through an interactive interface 54 associated with the purchase transaction. All of this information and data flows to the transaction database 52 for use in the analytical process by the processor mechanism 60 and eventual presentation of the purchase data set 12 or analytical report 24 to the user or merchant M.

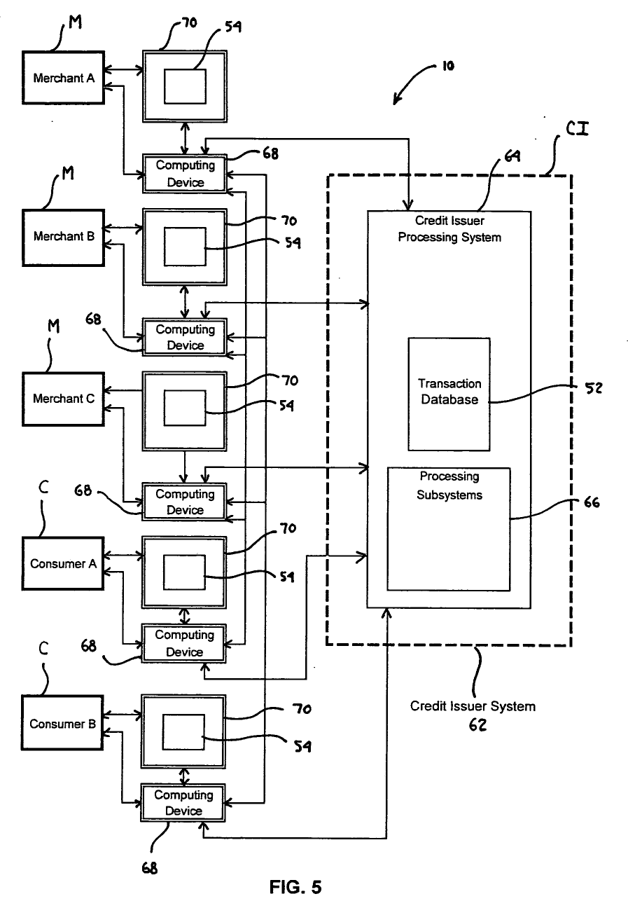

A further preferred and non-limiting embodiment is illustrated in FIG. 5. In this embodiment, the transaction database 52 is maintained as part of a credit issuer system 62. In particular, the transaction database 52 is part of and available to a credit issuer processing system 64, which includes various processing subsystems 66. One or more of these processing subsystems 66 are capable of processing and analyzing the transaction data set 13 and the data in the transaction database 52 for use in preparing and presenting the purchase data set 12 or analytical report 24 to the user. Of course, the various other processing subsystems 66 can engage in the various credit issuer CI processes discussed above. Further, in this embodiment, the credit issuer system 62 is connected to the credit issuer CI that has provided one or more credit products to the consumer C, and which credit product is being used in connection with the credit-based transaction. Therefore, the credit issuer system 62 obtains the transaction data 20 on a dynamic and ongoing basis.

Also as seen in the embodiment of FIG. 5, the credit issuer system 62 may be in communication with one or both of the merchant M and the consumer C. For example, as seen in FIG. 5, Consumer “A” and Consumer “B” are in communication with one or more of Merchant “A”, Merchant “B” and Merchant “C” through a computing device 68. Further, the computing device 68 is in communication with or otherwise drives the interactive interface 54, which may be a computer screen, monitor or other visual display apparatus 70. Furthermore, the information, such as the consumer data 16 and transaction data 20 (related to the consumer C) may be passed to the credit issuer system 64 through the merchant M or directly to the credit issuer system 64. In addition, each of the merchants M is also in communication with the credit issuer system 64 through a computing device 68 driving or otherwise in communication with a visual display apparatus 70. Accordingly, the overall system 10 provides a network and platform for communication of consumer data 16, merchant data 18, transaction data 20, purchase data 22, etc. by and between the consumer C, the merchant M and the credit issuer CI.

It is envisioned that a variety of data can be input, obtained, communicated, stored, analyzed and presented. For example, the transaction data may include data fields populated with data reflecting purchased items 28 or services, category 30 of purchased items 28 or services, price 32 of purchased items 28 or services, tax costs of purchased items 28 or services, shipping costs of purchased items 28, price range 46, tax or shipping costs of purchased items 28 or services, model information of purchased items 28, SKU (stock keeping unit) of purchased items 28, type or identification 48 of purchased items 28 or services, description of purchased items 28 or services, item group data, associated purchase of consumer C, associated selling merchant M, associated payment system or method, associated credit issuer CI, no-purchase data, consumer choice data, etc. The “no-purchase data” or consumer choice data (e.g., consumer action data 44) would be based upon consumer data 16 provided through the interactive interface 54 to either the merchant M or directly to the credit issuer CI regarding the consumer C experience, reasons for purchase, reasons for not purchasing, etc.

The merchant data 18 includes multiple data fields populated with data reflecting name, identification, code, contact information, an account number, an address, a city, a state, a zip code, a country, a telephone number, a facsimile number, an e-mail address, location, distributor data, store data, website data, category 30, product offerings, service offerings, associated items, associated services, field, focus field, focus application, focus category, item focus data, item group data, etc. In addition, credit data may include multiple data fields 14 populated with data reflecting payment system, credit issuer CI, name, identification, code, contact information, an address, a city, a state, a zip code, a country, a telephone number, a facsimile number, an e-mail address, location, participant data, credit product data 36, terms and conditions data, consumer/credit issuer data, consumer/credit issuer historical data, merchant/credit issuer data, merchant/credit issuer historical data, etc.

In order to provide the appropriate input information, the consumer data 16 also includes a variety of data fields 14 and information. For example, the consumer data 16 includes multiple data fields populated with data reflecting a name, a consumer key, a consumer identification, an account number, an address, a city, a state, a zip code, a country, a telephone number, a facsimile number, an e-mail address, a social security number, a date of birth, the merchant's name, an identification, an order number, an authorization number, an authorization time, an authorization amount, a ship-to address, a bill-to address, a transaction amount, a consumer purchase demographic, a transaction date, a transaction type, a product identification, a service identification, shipping costs, delivery type, consumer type, a company identity, a merchant identity, previous transaction data, geographical data, credit account data, bankcard balance data, delinquency data, credit segment data, previous transaction data, time between transactions data, previous transaction amount, previous transaction approval status, previous transaction time stamp data, a response code, consumer payment method, consumer payment history, consumer account history, consumer credit account balance, income data, family data, employment data, relationship data, expense data, application data, acknowledgement data, selection data, choice data, no-purchase data, consumer action data 44, etc.

The analytical report 24 can be provided to the merchant M or user in a variety of forms. Of course, as discussed above, the user is not limited to strictly the merchant M, but may also be a consumer C, a credit issuer CI, an auditor, a reviewer, a third party, a consultant, a gate or repository, etc. In addition, the analytical report 24 that is presented to the user may be in static form, dynamic form, manipulatable form, configurable form, user-configurable form, summary form, etc. Still further, this analytical report 24 may include data reflective of multiple consumers C, credit issuers CI, credit products, merchants M, categories 30, groupings, etc.

As discussed above, in one preferred and non-limiting embodiment, the credit-based transaction is an electronic transaction in an online environment. In this case, the F point-of-sale for the transaction is an online location of the merchant M. Still further, in this online environment, the presenting step includes displaying a web page, an electronic document, a window and/or a pop-up window, which would display the analytical report 24 to the user.

In a further embodiment, and as illustrated in FIG. 6, the system 10 includes a storage mechanism 72 housing or otherwise maintaining the transaction database 52. This system 10 includes one or more input mechanisms 74 for transmitting, to the storage mechanism 72, the transaction data set 12, which includes the consumer data 16, merchant data 18, transaction data 20 and/or credit data 22. The processor mechanism 60 is used to process and analyze the data input, data requests, data manipulation, data transmission, etc. In addition, a merchant output mechanism 76 is configured or otherwise enabled to present, to the merchant M, the analytical report 24. Accordingly, the storage mechanism 72 and/or processor mechanism 60 may be part of the credit issuer system 62, the credit issuer processing system 64, the credit issuer processing subsystem 66, a merchant M system, a payment system, an online payment system and/or a third-party system.

In this manner, the present invention provides a method 100 and system 10 for determining transactional data between a consumer C and a merchant M engaged in a purchase transaction that provides the merchant M (or user) with a purchase data set 12 and/or an analytical report 24. Therefore, the present invention provides a method 100 and system 10 for determining transactional data between the consumer C and the merchant M that provides the merchant M with valuable transactional data for further analysis and action. The method 100 and system 10 collects, analyzes and supplies the transactional data in the form of a purchase data set 12 and/or an analytical report 24 that is dynamic and further configurable by the user. In summary, the presently-invented method 100 and system 10 are robust, dynamic and provide the merchant M (or user) with valuable information in an analytical form for use in making appropriate consumer-directed decisions, and otherwise improve the processes and purchasing experience associated with that merchant M.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for determining transactional data between a consumer and a merchant engaged in a purchase transaction, comprising the steps of:
initiating or consummating a purchase transaction between at least one consumer and at least one merchant;
generating a transaction data set including a plurality of data fields populated with consumer data, merchant data, transaction data, purchase data or any combination thereof;
processing the plurality of data fields of the transaction data set; and
presenting a purchase data set including at least one data field therein.

2. The method of claim 1, wherein the purchase data set is presented at least partially in the form of an analytical report created by analyzing the transaction data based upon at least one of the plurality of data fields.

3. The method of claim 2, wherein the analytical report includes an itemized list of purchased items or services, category data of purchased items or services, price data of purchased items or services, manufacturer of purchased items, provider of purchased services, identification of items or services, associated purchasing consumer, consumer type, associated selling merchant, merchant type, payment system, associated payment system, associated credit issuer, credit issuer type, credit data, credit product data, no-purchase data, consumer choice data, consumer action data or any combination thereof.

4. The method of claim 2, wherein the analytical report is in electronic form, hardcopy form, presentation form or any combination thereof.

5. The method of claim 1, wherein the purchase data set is in electronic form, and wherein the purchase data set is presented to a user.

6. The method of claim 5, wherein the user is a merchant, a consumer, a credit issuer, an online payment system, an auditor, a reviewer, a third party, a consultant, a data repository or any combination thereof.

7. The method of claim 1, further comprising the step of building a transaction database including a plurality of data fields populated with at least one of the plurality of data fields of the transaction data set.

8. The method of claim 7, further comprising the step of presenting the purchase data set to a user on an interactive interface, which is in communication with the transaction database and configured to accept input data from the user.

9. The method of claim 8, wherein the interface is in communication with a central system, which is in communication with the transaction database, and wherein the central system is configured to: (i) authenticate the consumer; (ii) verify the consumer; (iii) approve or deny the transaction; (iv) verify the transaction; (v) process consumer data; (vi) process merchant data; (vii) process purchase data; (viii) process transaction data; (ix) process credit data, or any combination thereof.

10. The method of claim 7, wherein the transaction database is maintained by a credit issuer, the merchant, a third party, online, in electronic form, on a website, on an accessible medium, on a protected medium, as part of a system, as part of a third-party service system, as part of a payment system, as part of a merchant system or any combination thereof.

11. The method of claim 7, wherein the transaction database is maintained as part of a credit issuer system of a credit issuer, which has provided at least one credit product to the consumer, and which credit product is being used in connection with the credit-based transaction.

12. The method of claim 1, wherein the plurality of data fields of the purchase data set is arrangeable, sortable or configurable.

13. The method of claim 12, wherein the plurality of data fields of the purchase data set is arrangeable, sortable or configurable based upon input data of a user.

14. The method of claim 13, wherein the input data is category data of purchased items or services, price data of purchased items or services, manufacturer of purchased items, provider of purchased services, identification of items or services, associated purchasing consumer, associated selling merchant, associated payment system, associated credit issuer, credit data, credit product data, no-purchase data, consumer choice data, keyword data, key-phrase data, search data or any combination thereof.

15. The method of claim 1, wherein the transaction data includes at least one data field populated with data reflecting purchased items or services, category of purchased items or services, price of purchased items or services, tax costs of purchased items or services, shipping costs of purchased items, range of price, tax or shipping costs of items or services, manufacturer of purchased items, provider of purchased services, identification of purchased items or services, model information of purchased items, SKU (stock keeping unit) of purchased items, type of purchased items or services, description of purchased items or services, item group data, associated purchasing consumer, associated selling merchant, associated credit issuer, no-purchase data, consumer choice data or any combination thereof.

16. The method of claim 1, wherein the merchant data includes at least one data field populated with data reflecting name, identification, code, contact information, an account number, an address, a city, a state, a zip code, a country, a telephone number, a facsimile number, an e-mail address, location, distributor data, store data, website data, category, product offerings, service offerings, associated items, associated services, field, focus field, focus application, focus category, item focus data, item group data or any combination thereof.

17. The method of claim 1, wherein the purchase data includes at least one data field populated with data reflecting payment system or method, credit issuer, name, identification, code, contact information, an address, a city, a state, a zip code, a country, a telephone number, a facsimile number, an e-mail address, location, participant data, credit product data, terms and conditions data, consumer/credit issuer data, consumer/credit issuer historical data, merchant/credit issuer data, merchant/credit issuer historical data or any combination thereof.

18. The method of claim 1, wherein the consumer data includes at least one data field populated with data reflecting a name, a consumer key, a consumer identification, an account number, an address, a city, a state, a zip code, a country, a telephone number, a facsimile number, an e-mail address, a social security number, a date of birth, the merchant's name, an identification, an order number, an authorization number, an authorization time, an authorization amount, a ship-to address, a bill-to address, a transaction amount, a consumer purchase demographic, a transaction date, a transaction type, a product identification, a service identification, shipping costs, delivery type, consumer type, a company identity, a merchant identity, previous transaction data, geographical data, credit account data, bankcard balance data, delinquency data, credit segment data, previous transaction data, time between transactions data, previous transaction amount, previous transaction approval status, previous transaction time stamp data, a response code, consumer payment method, consumer payment history, consumer account history, consumer credit account balance, income data, family data, employment data, relationship data, expense data, application data, acknowledgement data, selection data, choice data, no-purchase data or any combination thereof.

19. The method of claim 1, further comprising the step of presenting the purchase data set to a user in an electronic form on a visual display apparatus in communication with a computing device.

20. The method of claim 1, wherein the purchase data set is presented to a user in a static form, a dynamic form, a manipulatable form, a configurable form, a user-configurable form, a summary form or any combination thereof.

21. The method of claim 1, wherein the purchase data set includes data reflective of a plurality of consumers, a plurality of credit issuers, a plurality of credit products, a plurality of merchants, a plurality of categories, a plurality of groupings or any combination thereof.

22. The method of claim 1, wherein the purchase transaction is an electronic transaction, and a point-of-sale for the transaction is an online location of the merchant.

23. The method of claim 1, wherein the presenting step includes displaying a web page, an electronic document, a window, a pop-up window, or any combination thereof, which displays the online purchase data set to a user.

24. The method of claim 1, wherein the purchase transaction is at an in-store location, over the telephone, in an online environment, at a point-of-sale or any combination thereof.

25. An apparatus for determining transactional data between a consumer and a merchant engaged in a purchase transaction, comprising:
means for initiating or consummating a purchase transaction between at least one consumer and at least one merchant;
means for generating a transaction data set including a plurality of data fields populated with consumer data, merchant data, transaction data, purchase data or any combination thereof;
means for processing the plurality of data fields of the transaction data set; and
means for presenting a purchase data set including at least one data field therein.

26. A system for determining transactional data between a consumer and a merchant engaged in a purchase transaction, comprising:
a storage mechanism including a transaction database;
at least one input mechanism for transmitting, to the storage mechanism, a transaction data set having a plurality of data fields populated with consumer data, merchant data, transaction data, purchase data or any combination thereof;
a processor mechanism configured to process data input, data requests, data manipulation, data transmission, or any combination thereof; and
a merchant output mechanism configured to present, to the merchant, a purchase data set having at least one data field therein.

27. The system of claim 26, wherein the storage mechanism and processor mechanism are part of a credit issuer system, a credit issuer processing system, a credit issuer subsystem, a merchant system, a third-party system, an online payment system or any combination thereof.
